(19) United States
(12) Patent Application Publication
(10) Pub. No.: US 2024/0286209 A1
(43) Pub. Date: Aug. 29, 2024

(54) METHOD AND APPARATUS FOR CUTTING GROOVES IN A BORE

(71) Applicants: John Laws, Newton, NC (US); Erdal Cig, Gaeufelden (DE)

(72) Inventors: John Laws, Newton, NC (US); Erdal Cig, Gaeufelden (DE)

(73) Assignee: GUHRING, INC., BROOKFIELD, WI (US)

(21) Appl. No.: 18/589,063

(22) Filed: Feb. 27, 2024

Related U.S. Application Data
(60) Provisional application No. 63/487,405, filed on Feb. 28, 2023.

(51) Int. Cl. B23D 37/00; B23D 41/04; B23D 41/08; B23D 43/00; B23D 43/06; F41A 21/18

(52) U.S. Cl. CPC B23D 37/005; B23D 41/04; B23D 41/086; B23D 43/005; B23D 43/06; B23D 2043/063; F41A 21/18

(57) ABSTRACT

A broaching tool, comprising a shank, a body and a cutting head that comprises at least one rake face. The rake face comprises a cutting edge that comprises a cutting corner at a forward end of the cutting head. The rake face is configured such that upon simultaneously rotating the broaching tool about the axis of the broaching tool and advancing the broaching tool along the axis of the broaching tool in a forward direction, the first corner travels in a first circular helix pattern. Also, a method of forming one or more grooves in a bore-containing structure, the method comprising simultaneously rotating a broaching tool and a bore-containing structure relative to one another about the axis, and moving the broaching tool and the bore-containing structure relative to one another along the axis. Also, methods of making broaching tools, and broaching machines.

This application claims the benefit of pending Provisional Patent Application Ser. No. 63/487,405, filed 28 Feb. 2023.

### BACKGROUND OF THE INVENTION

The present invention relates to tools, in particular to broaching tools for creating grooves in rifled gun barrels, for cutting grooves in a bore, to methods of using such tools, to methods of making such tools, and to broaching machines (each with at least one broaching tool).

There are a wide variety of instances where there is a need or a desire to cut grooves in a bore. There is an ongoing need for tools and methods that can cut grooves in bores more precisely, more rapidly, and/or using more readily available and/or less costly machines.

The present invention is a broaching tool particularly well suited for use in forming rifling grooves in firearm barrels by cutting helical grooves into the bore of the barrel. These grooves impart spin to the projectile, stabilizing its flight for increased accuracy and range.

Rifle barrels are commonly made from high-quality steel alloys. The choice of material can impact the barrel's strength, weight, and other characteristics. Stainless steel is increasingly used due to its corrosion resistance, while chrome-moly steel is also popular for its strength.

In order to manufacture a rifle barrel, the selected steel is often in the form of a cylindrical bar stock. The bar stock is then turned into a barrel blank using machining operations such as turning, drilling, and milling to achieve the basic shape of the barrel.

A bore is created in the bar stock by one of these methods, and next rifling grooves are formed within the bore. Rifling is the process of cutting grooves into the bore, or interior of a barrel. The grooves, and lands, which is the surface space between adjacent grooves, interacts with and imparts a spin to the bullet as the bullet travels through the barrel, stabilizing its flight.

In particular, when a bullet is fired through a rifled barrel, the lands of the barrel come into direct contact with the surface of the bullet. The surface interaction between the bullet and the lands/grooves in the rifle bore, or the barrel's interior, engage with the softer material of the bullet, causing a spin to be imparted to the bullet as the bullet moves down the barrel. The rotation stabilizes the bullet in flight, improving its accuracy.

Different firearms may have variations in the design of their rifling, such as the number and depth of grooves, the width of the lands, and the specific twist rate (the rate at which the rifling twists along the length of the barrel).

Rifling can be done through various methods, including button rifling, broach rifling, and hammer forging. In button rifling, a carbide button with the reverse pattern of the rifling is pushed or pulled through the barrel, displacing the metaling barrel material to create the grooves. In broach rifling, a broach with the rifling pattern is pulled through the barrel, cutting the grooves gradually. In hammer forging, the barrel blank is heated and then placed around a mandrel with the rifling pattern. A series of hammers shape the barrel around the mandrel.

Once the desired rifling pattern is formed in the bore, the barrel undergoes heat treatment processes to optimize its hardness and durability. This typically involves heating the barrel to a specific temperature and then cooling it in a controlled manner. The barrel is further machined to achieve the desired external shape and dimensions. This includes contouring the barrel to the specified profile.

The muzzle end of the barrel (where the bullet exits the barrel) is carefully machined to create a precise crown. The completed barrels are then assembled into the firearm, and additional components like the chamber and breech are integrated into the barrel.

Rifling a barrel is a precision process. The more precise the manufacturing process, the better the accuracy, durability, and safety of the rifle barrel.

### SUMMARY OF THE INVENTION

Disclosed is a self-stable broaching tool, preferably used as a push tool, and a method of using the broaching tool.

This section (i.e., “Summary of the Invention”) presents a simplified summary of the present invention in order to provide a basic understanding of some aspects of the invention. Included in this section are some concepts of the invention as a prelude to more detailed descriptions of aspects of the present invention, and representative embodiments in accordance with aspects of the present invention.

A primary aspect of the present invention is a broaching tool, and its use to form rifling in gun barrels.

In accordance with a second aspect of the present invention, there is provided a broaching tool, comprising a shank; a body; and a cutting head, an axis of the broaching tool extending from a rearward end of the broaching tool to a forward end of the broaching tool through the shank, the body and the cutting head, the body is forward relative to the shank, the cutting head is forward relative to the body, the cutting head comprises at least a first rake face, the first rake face comprises a first cutting edge, the first cutting edge comprises a first corner (or lead or leading edge, or lead angle) at a forward end of the cutting head, the first rake face is configured such that upon rotating the broaching tool about the axis of the broaching tool and advancing the broaching tool along the axis of the broaching tool in a forward direction, the first corner travels in a first circular helix pattern, each point on the first circular helix pattern spaced from the axis of the broaching tool by a distance that is greater than a distance that any point on the shank or the body is spaced from the axis of the broaching tool. It should be noted that as described herein, reference to rotation of the broaching tool is relative to the workpiece; meaning that the workpiece itself alone could be rotating relative to the broaching tool, the broaching tool alone could be rotating relative to the workpiece, or both the tool and workpiece may rotate relative to one another.

In some embodiments in accordance with the second aspect of the present invention, which can include or not include any of the other features described herein: the cutting head further comprises a second rake face and a third rake face, the second rake face comprises a second cutting edge, the second cutting edge comprises a second corner at the forward end of the cutting head, the second rake face is configured such that upon rotating the broaching tool about the axis of the broaching tool and advancing the broaching tool along the axis of the broaching tool in a forward direction, the second corner travels in a second circular helix pattern, each point on the second circular helix pattern spaced from the axis of the broaching tool by a distance that is greater than the distance that any point on the shank or the body is spaced from the axis of the broaching tool, the third rake face comprises a third cutting edge, the third cutting edge comprises a third corner at the forward end of the cutting head, the third rake face is configured such that upon rotating the broaching tool about the axis of the broaching tool and advancing the broaching tool along the axis of the broaching tool in a forward direction, the third corner travels in a third circular helix pattern, each point on the third circular helix pattern spaced from the axis of the broaching tool by a distance that is greater than the distance that any point on the shank or the body is spaced from the axis of the broaching tool.

In some of such embodiments: the first cutting corner, the second cutting corner and the third cutting corner are each located on an imaginary substantially circular pattern, the imaginary substantially circular pattern is in a plane perpendicular to the axis of the broaching tool, a spacing between the first cutting corner and the second cutting corner on the imaginary substantially circular pattern is in the range of from 115 degrees to 125 degrees, a spacing between the second cutting corner and the third cutting corner on the imaginary substantially circular pattern is in the range of from 115 degrees to 125 degrees, and a spacing between the third cutting corner and the first cutting corner on the imaginary substantially circular pattern is in the range of from 115 degrees to 125 degrees (i.e., consistent with the definition of “substantially” uniformly spaced discussed below, the cutting corners are substantially uniformly spaced on the forward end of the cutting head).

In some embodiments in accordance with the second aspect of the present invention, which can include or not include any of the other features described herein: the cutting head comprises at least two rake faces, including the first rake face, each rake face comprises a respective cutting corner at the forward end of the cutting head, and the respective cutting corners of the at least two rake faces are substantially uniformly spaced on the forward end of the cutting head.

In some embodiments in accordance with the second aspect of the present invention, which can include or not include any of the other features described herein: the cutting head comprises at least two rake faces, including the first rake face, each rake face comprises a respective cutting corner at the forward end of the cutting head, and the respective cutting corners of the at least two rake faces are non-uniformly spaced on the forward end of the cutting head.

In some embodiments in accordance with the second aspect of the present invention, which can include or not include any of the other features described herein: the broaching tool further comprises a pilot portion, each point on the pilot portion is spaced from the axis of the broaching tool a distance that is less than a distance that each point on the first circular helix pattern is spaced from the axis of the broaching tool. In some of such embodiments, the pilot portion extends farther in the forward direction than any other part of the broaching tool.

In some embodiments in accordance with the second aspect of the present invention, which can include or not include any of the other features described herein, the cutting head is removable from the body.

In some of such embodiments: the cutting head has a region with external threads, the body has a region with internal threads, and the external threads of the cutting head are capable of being screw-threaded into the internal threads of the body, and/or the body has a region with external threads, the cutting head has a region with internal threads, and the external threads of the body are capable of being screw-threaded into the internal threads of the cutting head.

In some embodiments in accordance with the second aspect of the present invention, which can include or not include any of the other features described herein, the body is removable from the shank.

In some of such embodiments: the body has a region with external threads, the shank has a region with internal threads, and the external threads of the body are capable of being screw-threaded into the internal threads of the shank, and/or the shank has a region with external threads, the body has a region with internal threads, and the external threads of the shank are capable of being screw-threaded into the internal threads of the body.

In some embodiments in accordance with the second aspect of the present invention, which can include or not include any of the other features described herein: the shank comprises at least a shank first ramp portion, in a sequence of at least first through tenth shank imaginary planes that are perpendicular to the axis of the broaching tool and that are spaced evenly, respective dimensions of the shank first ramp portion increase as the distance from the cutting head increases. In some of such embodiments, for said sequence of first through tenth shank imaginary planes, respective dimensions of the shank first ramp portion increase substantially linearly.

In some embodiments in accordance with the second aspect of the present invention, which can include or not include any of the other features described herein, the body comprises at least a body first ramp portion, in a sequence of at least first through tenth body imaginary planes that are perpendicular to the axis of the broaching tool and that are spaced evenly, respective dimensions of the body first ramp portion decrease as the distance from the cutting head increases. In some of such embodiments, for said sequence of first through tenth body imaginary planes, respective dimensions of the body first ramp portion decrease substantially linearly.

In some embodiments in accordance with the second aspect of the present invention, which can include or not include any of the other features described herein, the shank comprises at least a first indexing region.

In some of such embodiments: the indexing region comprises at least first and second indexing surfaces at a rear face of the shank, and the first and second indexing surfaces are non-co-planar, and/or the indexing region comprises at least a first groove, and/or the indexing region comprises at least a first rib, and/or the indexing region comprises at least a first non-cylindrical, non-conical, non-frustoconical recess, and/or the indexing region comprises at least a first non-cylindrical, non-conical, non-frustoconical protrusion, and/or the indexing region comprises at least two protrusions, and/or the indexing region comprises at least two recesses, and/or the indexing region comprises at least one protrusion and at least one recess.

In accordance with a third aspect of the present invention, there is provided a method of forming one or more grooves in a bore-containing structure, the method comprising: simultaneously: rotating a broaching tool and a bore-containing structure relative to one another about a first axis, the broaching tool and the bore-containing structure aligned such that the first axis is an axis of the broaching tool and an axis of a bore in the bore-containing structure, and moving the broaching tool and the bore-containing structure relative to one another along the first axis, so that a cutting head of the broaching tool cuts at least a first groove pattern in the bore-containing structure around the bore, the first groove pattern a first circular helix relative to the first axis, the broaching tool comprising: a shank; a body; and the cutting head, the axis extending from a rearward end of the broaching tool to a forward end of the broaching tool through the shank, the body and the cutting head, the body is forward relative to the shank, the cutting head is forward relative to the body, the cutting head comprises at least a first rake face, the first rake face comprises a first cutting edge, the first cutting edge comprises a first corner at a forward end of the cutting head.

In some embodiments in accordance with the third aspect of the present invention, which can include or not include any of the other features described herein, said moving the broaching tool and the bore-containing structure relative to one another along the first axis causes the broaching tool to move forward relative to the bore-containing structure.

In some embodiments in accordance with the third aspect of the present invention, which can include or not include any of the other features described herein: said rotating the broaching tool and the bore-containing structure relative to one another about the first axis comprises rotating the broaching tool about the first axis (and optionally also rotating the bore-containing structure about the first axis), and said moving the broaching tool and the bore-containing structure relative to one another along the first axis comprises moving the broaching tool along the first axis (and optionally also moving the bore-containing structure along the first axis).

In some embodiments in accordance with the third aspect of the present invention, which can include or not include any of the other features described herein: said rotating the broaching tool and the bore-containing structure relative to one another about the first axis comprises rotating the bore-containing structure about the first axis, and said moving the broaching tool and the bore-containing structure relative to one another along the first axis comprises moving the bore-containing structure along the first axis.

In some embodiments in accordance with the third aspect of the present invention, which can include or not include any of the other features described herein: said rotating the broaching tool and the bore-containing structure relative to one another about the first axis comprises rotating the bore-containing structure about the first axis, and said moving the broaching tool and the bore-containing structure relative to one another along the first axis comprises moving the broaching tool along the first axis.

In some embodiments in accordance with the third aspect of the present invention, which can include or not include any of the other features described herein: said rotating the broaching tool and the bore-containing structure relative to one another about the first axis comprises rotating the broaching tool about the first axis, and said moving the broaching tool and the bore-containing structure relative to one another along the first axis comprises moving the bore-containing structure along the first axis.

In some embodiments in accordance with the third aspect of the present invention, which can include or not include any of the other features described herein: the cutting head comprises at least two rake faces, including the first rake face, each rake face comprises a respective cutting corner at the forward end of the cutting head, and the respective cutting corners of the at least two rake faces are substantially uniformly spaced on the forward end of the cutting head.

In some embodiments in accordance with the third aspect of the present invention, which can include or not include any of the other features described herein: the cutting head comprises at least two rake faces, including the first rake face, each rake face comprises a respective cutting corner at the forward end of the cutting head, and the respective cutting corners of the at least two rake faces are non-uniformly spaced on the forward end of the cutting head.

In some embodiments in accordance with the third aspect of the present invention, which can include or not include any of the other features described herein: the cutting head further comprises a second rake face and a third rake face, the second rake face comprises a second cutting edge, the second cutting edge comprises a second corner at the forward end of the cutting head, the third rake face comprises a third cutting edge, the third cutting edge comprises a third corner at the forward end of the cutting head, upon said rotating the broaching tool and the bore-containing structure relative to one another about the first axis, and said moving the broaching tool and the bore-containing structure relative to one another along the first axis, the second cutting edge cuts a second groove pattern in the bore-containing structure around the bore, and the third cutting edge cuts a third groove pattern in the bore-containing structure around the bore, the second groove pattern a second circular helix relative to the first axis, the third groove pattern a third circular helix relative to the first axis, the second circular helix axially offset relative to the first circular helix, the third circular helix axially offset relative to the first circular helix and relative to the second circular helix.

In some embodiments in accordance with the third aspect of the present invention, which can include or not include any of the other features described herein: the broaching tool further comprises a pilot portion, the pilot portion extends farther in the forward direction than any other part of the broaching tool, and upon said moving the broaching tool and the bore-containing structure relative to one another along the first axis, the pilot portion enters the bore prior to the cutting head of the broaching tool cutting the first groove pattern in the bore-containing structure.

In some embodiments in accordance with the third aspect of the present invention, which can include or not include any of the other features described herein: the method further comprises again simultaneously: rotating the broaching tool and the bore-containing structure relative to one another about the first axis, the broaching tool and the bore-containing structure aligned such that the first axis is an axis of the broaching tool and an axis of a bore in the bore-containing structure, and moving the broaching tool and the bore-containing structure relative to one another along the first axis, so that the cutting head of the broaching tool cuts at least a second groove pattern in the bore-containing structure around the bore, the second groove pattern comprising at least one circular helix relative to the first axis.

In some of such embodiments, the method further comprises indexing the broaching tool relative to the bore-containing structure prior to said again simultaneously rotating the broaching tool and the bore-containing structure relative to one another about the first axis, and moving the broaching tool and the bore-containing structure relative to one another along the first axis, and/or coils of the second groove pattern are offset axially from coils of the first groove pattern by a distance equal to from 45% to 55% of a shift of the first groove pattern, or coils of the second groove pattern are offset axially from coils of the first groove pattern by a distance outside the range of from 45% to 55% of a shift of the first groove pattern.

In some embodiments in accordance with the third aspect of the present invention, which can include or not include any of the other features described herein: the method further comprises simultaneously: rotating a second broaching tool and the bore-containing structure relative to one another about the first axis, the second broaching tool and the bore-containing structure aligned such that the first axis is an axis of the second broaching tool and an axis of a bore in the bore-containing structure, and moving the second broaching tool and the bore-containing structure relative to one another along the first axis, so that the cutting head of the second broaching tool cuts at least a second groove pattern in the bore-containing structure around the bore, the second groove pattern comprising at least one circular helix relative to the first axis.

In some of such embodiments: the method further comprises indexing the second broaching tool relative to the bore-containing structure prior to said simultaneously rotating the second broaching tool and the bore-containing structure relative to one another about the first axis, and moving the second broaching tool and the bore-containing structure relative to one another along the first axis, and/or coils of the second groove pattern are offset axially from coils of the first groove pattern by a distance equal to from 45% to 55% of a shift of the first groove pattern, or coils of the second groove pattern are offset axially from coils of the first groove pattern by a distance outside the range of from 45% to 55% of a shift of the first groove pattern.

In some embodiments in accordance with the third aspect of the present invention, which can include or not include any of the other features described herein, the bore is substantially cylindrical.

In some embodiments in accordance with the third aspect of the present invention, which can include or not include any of the other features described herein, the bore-containing structure is a gun barrel.

The invention may be more fully understood with reference to the accompanying drawings and the following detailed description of the invention.

### BRIEF DESCRIPTION OF DRAWINGS

FIG. 1 is an end view of a rifled barrel formed with a broaching tool 10 of the present invention, FIG. 1A a close-up of a land and groove formed within the barrel;

FIG. 1B is a schematic side view depicting a first embodiment of a broaching tool 10 in accordance with the present invention

FIG. 2 is a schematic perspective view depicting the cutting head 13 (and part of the body 12) of the broaching tool 10;

FIG. 3 is a close-up view corresponding to part of FIG. 2;

FIG. 4 is a schematic front view of the broaching tool 10, showing the front face of the cutting head 13 of a first embodiment of the broaching tool 10;

FIG. 4A is a schematic front view of the broaching tool 10, showing the front face of the cutting head 13 of a second embodiment of the broaching tool 10;

FIG. 4B is a front view of the broaching tool 10 deployed and in-use operating on a barrel;

FIGS. 5 and 6 are side views of the cutting head 13 and a portion of the body 12 (the view in FIG. 6 being rotated about the axis about 60 degrees relative to the view in FIG. 5, and viewed slightly from a bottom perspective);

FIG. 7 is a schematic conceptual drawing depicting a CNC lathe machine, including a pushing component 56 and a bore-containing structure holder 57;

FIG. 8 is a schematic conceptual drawing depicting indexing surfaces 54 and 55 of the pushing component 56 with surfaces that cooperate with indexing surfaces on a back face of the shank of a broaching tool;

FIG. 9 is a schematic side view depicting a second embodiment of a broaching tool 60 in accordance with the present invention;

FIG. 10 is a schematic side view depicting part of a third embodiment of a broaching tool 70 in accordance with the present invention;

FIG. 11 is a schematic side view depicting part of a fourth embodiment of a broaching tool 80 in accordance with the present invention;

FIG. 12 is a schematic side view depicting a fifth embodiment of a broaching tool 90 in accordance with the present invention;

FIG. 13 is a schematic side view depicting part of a sixth embodiment of a broaching tool 100 in accordance with the present invention;

FIG. 14 is a schematic sectional view depicting part of a pushing component 110 and part of a broaching tool 111;

FIG. 15 is a schematic view depicting a front surface of the pushing component 110;

FIG. 16 is a schematic view depicting a rear surface of the broaching tool 111;

FIG. 17 is a schematic sectional view depicting part of a pushing component 120 and part of a broaching tool 121.

FIG. 18 is a schematic view depicting a front surface of a pushing component 130;

FIG. 19 is a schematic view depicting a rear surface of a broaching tool 132;

FIG. 20 is a schematic view depicting a front surface of a pushing component 140;

FIG. 21 is a schematic view depicting a rear surface of a broaching tool 143;

FIG. 22 is a schematic view depicting a front surface of a pushing component 150;

FIG. 23 is a schematic view depicting a rear surface of a broaching tool 152;

FIG. 24 is a schematic front view of a seventh embodiment of a broaching tool 166;

FIG. 25 is a side view of an eighth embodiment of a broaching tool 170;

FIG. 26 is a side view of a ninth embodiment of a broaching tool 180;

FIG. 27 is a front, in-use view thereof;

FIG. 28 is a side view of an tenth embodiment of a broaching tool 190;

FIG. 29 is a front, in-use view thereof;

FIG. 30 is a top perspective view of an eleventh embodiment of a broaching tool 200;

FIG. 31 is a top view thereof;

FIG. 32 is a side view thereof;

### DETAILED DESCRIPTION OF THE INVENTION

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

The expression “invention” is used herein to refer to any portion (or portions) of the inventive subject matter disclosed herein. As described herein, the present invention includes many aspects.

The expression “comprises” or “comprising,” as used herein, is used in accordance with its well-known usage, and means that the item that “comprises” the recited elements (or that is “comprising” the recited elements) includes at least the recited elements, and can optionally include any additional elements. For example, a broaching tool, comprising a shank; a body; and a cutting head includes at least a shank; a body; and a cutting head, and it can include any additional elements. Also, an item that “comprises a first cutting edge” includes at least one a first cutting edge, i.e., it can include a single cutting edge or a plurality of cutting edges. An item that comprises at least first and second recited elements can include the two recited elements or can include three or more of the recited elements.

Where an expression is defined herein in terms of the meaning of the expression in the singular, the definition applies also to the plural (and vice-versa, i.e., for an expression defined herein in the plural, the definition applies also to the singular). Definitions of one form of an expression apply to the same expression in a different form of the word or words.

The term “bore” is used herein in accordance with its well-known meaning, to refer to an opening in a structure. A bore (as the term is used herein) can extend part of the way or all of the way through the structure. For example, a bore can refer to the hollow part of a tube-shaped structure, e.g., a substantially cylindrical opening (such as the inside of a barrel of a gun, e.g., a rifle or a pistol).

The expression “circular helix” is used herein in accordance with its well-known meaning, to refer to an imaginary geometrical shape defined by a set of points that are spaced substantially the same distance from an axis (i.e., the helix has a constant radius) and that form a spiral shape consisting of a plurality of coils, each coil extending 360 degrees around the axis, each coil extending substantially the same distance along the axis, and within each coil, the spiral shape advances substantially the same distance along the axis per circumferential advancement around the axis. In accordance with well-known usage, the term “shift” refers to the distance between adjacent coils, i.e., the uniform (substantially the same) distance, along a line that is parallel to the axis, between a point on one coil and a point on an adjacent coil.

The expression “substantially the same distance,” as used herein, means that the distance (or each distance) is in the range of 0.95 to 1.05 times a particular distance, e.g., an average distance.

The expression “the first cutting corner, the second cutting corner and the third cutting corner are each located on an imaginary substantially circular pattern,” as used herein, means that a circle can be drawn having the formula x²+y²=n, where imaginary axes could be drawn at a location where for each of the cutting corners, the y coordinate would be within 0.95 to 1.05 times the value obtained by inserting the x coordinate of such point into such formula, and the z coordinate, i.e., the location relative to the axis of the broaching tool (i.e., the location along the axis of the broaching tool of an imaginary plane in which the cutting corner is located) is within 0.95 to 1.05 times the length of the broaching tool along its axis (and in some embodiments, within 0.98 to 1.02 times the length of the cutting head of the broaching tool).

The expression “removable,” as used herein (e.g., in the expression “the cutting head is removable from the body” or the expression “the body is removable from the shank”) means that the element that is described as being removable from a second element can be removed from the second element without severing any material or breaking any structure, e.g., by unscrewing one structure relative to the other, or by unscrewing both structures relative to a connector.

The expression “distance between a point and the axis,” as used herein (e.g., in the expression “each point on the first circular helix pattern spaced from the axis by a distance that is greater than a distance that any point on the shank is spaced from the axis” or the expression “each point on the pilot portion is spaced from the axis a distance that is less than a distance that each point on the first circular helix pattern is spaced from the axis”), means the distance to the nearest point that is on the axis, i.e., the distance along a plane that includes the point and that is perpendicular to the axis.

The expression “substantially cylindrical”, as used herein in relation to a surface, means that at least 95 percent of the points in the surface that is characterized as being substantially cylindrical are located on one of or between a pair of imaginary cylindrical structures that have the same axis, one of the imaginary cylindrical structures having a radius of 1.05 times the radius of the other imaginary cylindrical structure.

The expression “substantially linearly,” as used herein (e.g., in the expression “for said sequence of first through tenth imaginary planes, respective dimensions of the first ramp portion increase substantially linearly”), means that for each of the second through tenth imaginary planes, a dimension of the first ramp portion in the respective imaginary plane is an amount larger than a dimension of the first ramp portion in the immediately preceding ramp portion, said amount being in the range of from 0.90 to 1.10 times a particular distance (e.g., the diameter of the first ramp portion might be 5.50 mm in the first imaginary plane, 5.80 mm in the second imaginary plane, 6.10 mm in the third imaginary plane, 6.40 mm in the fourth imaginary plane, 6.70 mm in the fifth imaginary plane, 6.97 mm in the sixth imaginary plane, 7.30 mm in the seventh imaginary plane, 7.63 mm in the eighth imaginary plane, 7.90 mm in the ninth imaginary plane, and 8.21 mm in the tenth imaginary plane, the “particular distance” being 0.30 mm).

The expression “the respective cutting corners of the at least two rake faces are substantially uniformly spaced on the forward end of the cutting head”, means that viewing the broaching tool from the front end, the spacing between each cutting corner and the cutting corners of each of its circumferentially neighboring rake faces (i.e., the circumferentially nearest cutting corners) is in the range of from 0.90 to 1.10 times a particular angular amount (e.g., in a broaching tool that has three rake faces, the respective cutting corners at the forward end of the cutting head are at 0 degrees, 120 degrees and 240 degrees, or at 0 degrees, 108 degrees, and 234 degrees, the “particular angular amount” being 120 degrees; or, in a broaching tool that has four rake faces, the respective cutting corners at the forward end of the cutting head are at 0 degrees, 90 degrees, 180 degrees and 270 degrees, or at 0 degrees, 99 degrees, 198 degrees, and 279 degrees, the “particular angular amount” being 90 degrees).

The expression “the respective cutting corners of the at least two rake faces are non-uniformly spaced on the forward end of the cutting head”, means that viewing the broaching tool from the front end, there is no particular angular amount that would satisfy the expression that the spacing between each cutting corner and the cutting corners of each of its circumferentially neighboring rake faces (i.e., the circumferentially nearest cutting corners) is in the range of from 0.90 to 1.10 times the particular angular amount (e.g., in a broaching tool that has three rake faces, the respective cutting corners at the forward end of the cutting head are at 0 degrees, 110 degrees and 220 degrees, or at 0 degrees, 140 degrees, and 250 degrees, the “particular angular amount” being 120 degrees).

Unless otherwise defined, all terms (including technical and scientific terms) used herein have the same meaning as commonly understood by one of ordinary skill in the art to which this invention belongs. Terms and expressions, such as those defined in commonly used dictionaries, should each be interpreted as having a meaning that is consistent with their meaning in the context of the relevant art and the present disclosure, and not in an idealized or overly formal sense (unless expressly so defined herein).

As discussed above, the present invention relates to broaching tools, methods of using broaching tools, methods of making broaching tools, methods of cutting grooves in a bore, broaching machines with broaching tools, and bore-containing structures in which grooves have been cut by a broaching tool or a broaching method in accordance with the present invention. A broaching tool according to the present invention can be used with any suitable broaching machine, to perform a method of cutting one or more grooves in a bore.

Broaching tools in accordance with the present invention are especially useful, in that they can be used with conventional push (or pull) broaching machines, including standard metal-working rotary broaching machines, e.g., CNC (computerized numerical control) milling machines and CNC lathe machines. Such machines provide for synchronized rotary and forward motion, i.e., such that a broaching tool and a bore-containing structure (i.e., the bore being worked on, i.e., the bore in which one or more grooves is/are being formed) can be rotated relative to one another about a first axis, while the broaching tool and the bore-containing structure are being moved relative to one another along the first axis.

As noted above, in accordance with a second aspect of the present invention, there is provided a broaching tool that comprises a shank, a body, and a cutting head. In some embodiments, the shank and the body can be one and the same.

The shank, the body and the cutting head can comprise any suitable material, a variety of which are known to those of skill in the art (e.g., hardened steel, carbon steel, high-speed steel (HSS), cobalt high-speed steel, etc., optionally with any suitable coating or coatings (e.g., titanium nitride, zirconium nitride, diamond, etc.)).

As noted above, in some embodiments, the broaching tool comprises plural rake faces, each rake face comprises a respective cutting corner at the forward end of the cutting head, and the respective cutting corners of the rake faces are substantially uniformly spaced on the forward end of the cutting head. In such embodiments (particularly embodiments that have three or more rake faces), the presence of multiple rake faces can help to stabilize the broaching tool (and/or to balance forces acting on the broaching tool, the bore-containing structure being worked on, and the broaching machine) as the broaching tool cuts grooves in a bore.

As noted above, in some embodiments, the broaching tool comprises a pilot portion. In such embodiments, the pilot portion enters the bore, either before or after the rake face (or rake faces) start cutting a groove (or grooves) in the bore. A pilot portion (if included) can help to guide the broaching tool into the bore, and/or can help to stabilize the broaching tool as it cuts grooves in the bore.

As noted above, in some embodiments, the cutting head is removable from the body (e.g., it can be screw-threaded to the body). In such embodiments, manufacture of the broaching tool can be simplified, because the cutting head can be formed and shaped independently from the body and the shank. In addition, in such embodiments, if the cutting edges and/or the cutting corners on a cutting head become worn down, the cutting head can be replaced without the need to replace the body or the shank.

As noted above, in some embodiments, the body is removable from the shank (e.g., it can be screw-threaded to the shank)(and/or the body is removable from the cutting head). In such embodiments, manufacture of the broaching tool can be simplified, because the body can be formed and shaped independently from the shank (and/or the cutting head). In addition, in such embodiments, if there is a need or desire to alter a characteristic of the body, a body having the desired characteristic (or characteristics) can be easily substituted for the body to which the shank and/or the cutting head are attached.

As noted above, in some embodiments, the shank comprises at least one indexing region. An indexing region on a broaching tool cooperates with a corresponding indexing region on the broaching machine, to permit the rotational position of a broaching tool to be precisely controlled. The relationship between the respective indexing regions prevent the broaching tool from slipping rotationally relative to the broaching machine, which would otherwise result in a loss of the precise synchronization of the rotational movement and the forward movement (of the broaching tool relative to the bore being worked on). In addition, if a cutting operation has to be discontinued before its completion, e.g., because a part of the broaching tool (e.g., a cutting edge) breaks before completing the formation of a groove or grooves, or because something causes the broaching tool to jam, the broaching tool can be replaced with another broaching tool, and upon resuming the cutting operation, the replacement broaching tool will resume cutting precisely where the cutting by the prior broaching tool was discontinued. Also, if a cutting operation is designed to be performed in multiple passes, e.g., one or more grooves are cut in a first pass and one or more additional grooves are cut in a second (or more) pass, the location(s) of the additional grooves, in relation to the location(s) of the grooves cut in the first pass (or the prior passes) can be precisely selected and controlled.

As indicated above, there are a variety of indexing regions that can be employed. For example, a rear face of a broaching tool can have an indexing region that comprises at least two surfaces that abut two or more corresponding surfaces in a broaching machine. Alternatively or additionally:
a broaching tool can have a groove that engages a corresponding rib (or ribs) on a broaching machine (or the broaching tool can have plural grooves that engage corresponding ribs on a broaching machine);
a rear surface of a broaching tool can have a rib that engages a corresponding groove on a broaching machine (or the broaching tool can have plural ribs that engage one or more corresponding grooves on a broaching machine);
a broaching tool can have a non-cylindrical, non-conical, non-frustoconical recess that engages a corresponding protrusion on a broaching machine (or the broaching tool can have plural non-cylindrical, non-conical, non-frustoconical recesses that engage corresponding protrusions on a broaching machine);
a rear surface of a broaching tool can have a non-cylindrical, non-conical, non-frustoconical protrusion that engages a corresponding recess on a broaching machine (or the broaching tool can have plural non-cylindrical, non-conical, non-frustoconical protrusions that engage corresponding recesses on a broaching machine);
a broaching tool can have one or more protrusions and one or more recesses that engage one or more corresponding recesses and one or more corresponding protrusions on the broaching machine, etc.

Broaching tools in accordance with the present invention can be used to provide any number of grooves in a bore, where the grooves have any desired width (and depth), e.g., a width of 1/16 inch, and where the groove or grooves have circular helice(s) of any desired shift (i.e., for each helix, the distance between successive coils), and where the grooves (where multiple grooves are formed) are spaced from each other in any desired way (e.g., first, second and third helices are spaced evenly (or non-evenly) along their common longitudinal axes). The width of each groove is controlled by the length and angle of the cutting edge, and by the rate of advancement (forward in a push operation or backward in a pull operation) of the broaching tool (relative to the bore) vs. the rate of rotation of the broaching tool (relative to the bore). If multiple grooves are formed in a single pass (i.e., if the broaching tool has plural cutting edges), the positioning of grooves (relative to one another) formed in the same pass is controlled by the circumferential spacing of the cutting edges on the broaching tool, and the rate of advancement vs. the rate of rotation. If grooves are formed in multiple passes of the same broaching tool, the positioning of the grooves formed in one pass (relative to the positioning of grooves formed in any other pass) is controlled by the relative indexing of the broaching tool, and the rate of advancement vs. the rate of rotation. If grooves are formed in multiple passes of different broaching tools, the positioning of the grooves formed in one pass (relative to the positioning of grooves formed in any other pass) is controlled by the relative indexing of the respective broaching tools, as well as by the rate of advancement and the rate of rotation in the respective passes, as well as the number of cutting edges and the spacing of the cutting edges in the respective broaching tools.

By dividing the forming of grooves into more than one pass (e.g., forming three grooves in each of two passes, rather than making six grooves in one pass), the load that needs to be applied by the broaching machine to the broaching tool is significantly reduced, thereby reducing the stress on the broaching machine and reducing the likelihood of breaking the broaching tool.

The number of grooves formed in a bore is controlled by the number of passes and the number of cutting edges on the broaching tool(s) used on each of the one or more passes. For example, if there is a desire to provide six evenly spaced grooves each of equal shift, a broaching tool in accordance with the present invention and having three cutting edges that are spaced equally circumferentially can be used for two passes, with the broaching tool offset by 60 degrees (or by 180 degrees, or by 300 degrees) at the start of the second pass (relative to its rotational position to start the first pass). As another example, if there is a desire to provide fifteen evenly spaced grooves each of equal shift, a broaching tool in accordance with the present invention and having three cutting edges that are spaced equally circumferentially can be used for five passes, as follows:
First pass: start with the broaching tool in any rotational position;
Second pass: start with the broaching tool offset by 24 degrees (or by 144 degrees, or by 264 degrees), relative to its rotational position to start the first pass;
Third pass: start with the broaching tool offset by 48 degrees (or by 168 degrees, or by 288 degrees), relative to its rotational position to start the first pass;
Fourth pass: start with the broaching tool offset by 72 degrees (or by 192 degrees, or by 312 degrees), relative to its rotational position to start the first pass;
Fifth pass: start with the broaching tool offset by 96 degrees (or by 216 degrees, or by 336 degrees), relative to its rotational position to start the first pass.

The broaching tools and the broaching methods described herein are particularly effective for rifling barrels of firearms, e.g., rifle bores and pistol bores. Representative examples include rifle barrels with from 1 to 20 lands (i.e., 1 to 20 grooves), such as 4 lands, 6 lands or 8 lands, and pistol barrels with 6 lands and 6 grooves.

The present invention now will be described more fully hereinafter with reference to the accompanying drawings, in which representative embodiments of the invention are shown. However, the present invention should not be construed as being limited to the specific features in the embodiments set forth herein.

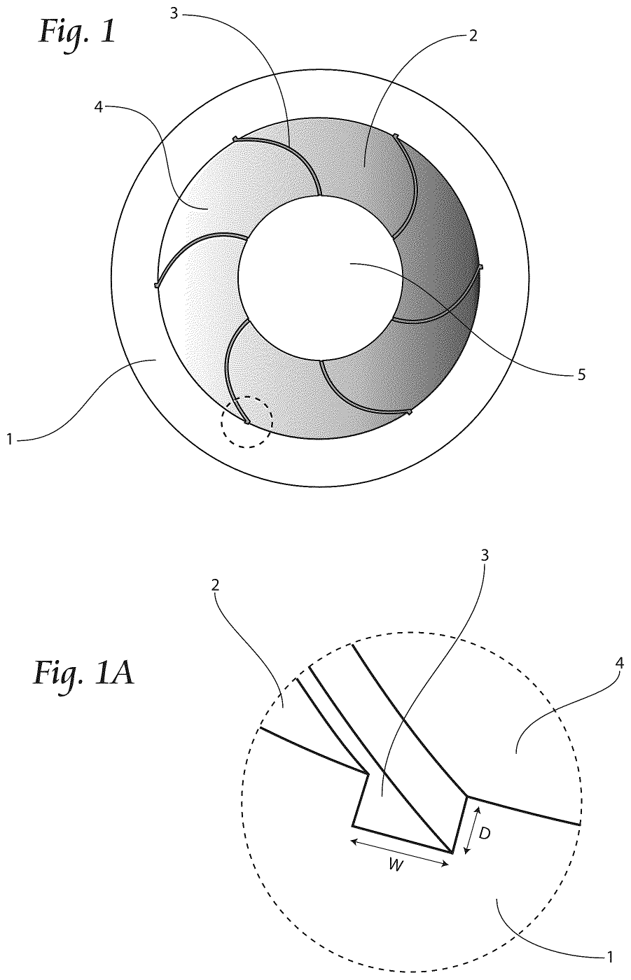

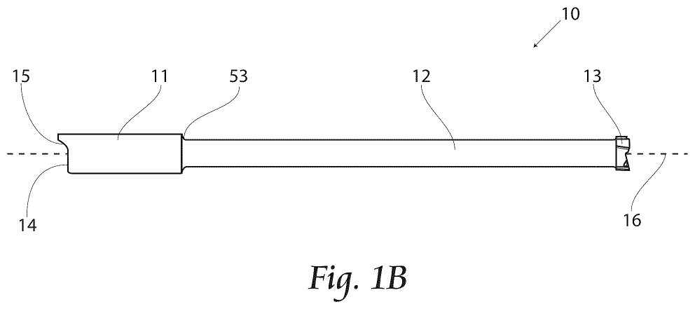

FIG. 1 is a schematic side view depicting a first embodiment of a broaching tool 10 in accordance with the present invention.

Referring to FIG. 1, the broaching tool 10 comprises a shank 11, a body 12 and a cutting head 13. The rear face of the shank 11 includes an indexing region comprising first and second indexing surfaces 14 and 15.

Referring now to FIG. 1, an end view of rifle barrel 1 is shown. The broaching tool 10 of FIG. 1B described later is used to form grooves 3 of a rifle barrel 1. Rifle barrel 1 comprises a solid hollowed out body with a bore 2 formed therethrough. A muzzle 5 is the projectile discharge portion of the rifle barrel 1. A series of rifled grooves 3 are formed in the bore 2 of the barrel 1 by the broaching tool 10, and the rifled grooves 3 alternate with a series of lands 4, the lands 4 positioned closer to a center radius of barrel 1 than the rifled grooves 3.

FIG. 1A a close-up of a land 4 and groove 3 formed within the bore 2 of barrel 1. The groove 3 has a width W and a depth D. The dimensions of width W and a depth D can be chosen by a manufacturer to their specifications. Some manufacturers may choose deeper or wider grooves 3, some may choose shallower or narrower.

As seen in FIG. 1B, an (imaginary) axis 16 extends from a rearward end of the broaching tool (to the left in the orientation shown in FIG. 1) to a forward end (to the right in the orientation depicted in FIG. 1) of the broaching tool through the shank 11, the body 12 and the cutting head 13.

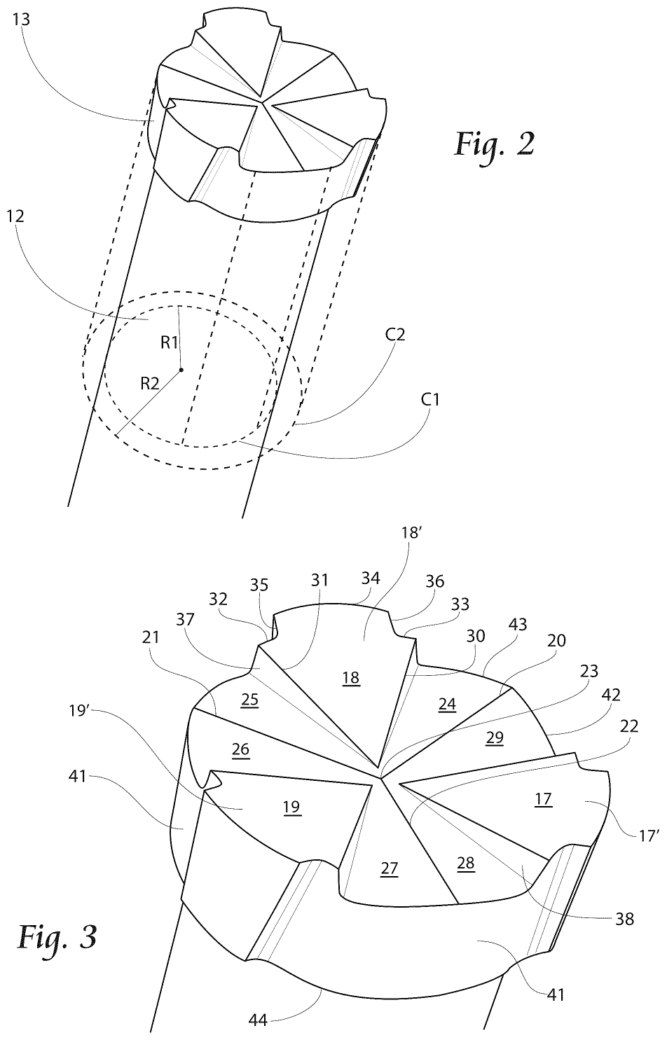

Referring now to FIGS. 2 and 3, perspective views are shown depicting the cutting head 13 (and part of the body 12) of the broaching tool 10, with FIG. 3 a close-up view corresponding to part of FIG. 2.

Referring still to FIGS. 2 and 3, the cutting head 13 comprises a first rake face 17, a second rake face 18 and a third rake face 19. Each of the first, second and third rake faces 17-19 has a main surface (17′, 18′, and 19′ respectively) that is preferably substantially planar and inclined by about 12 degrees relative to an imaginary plane perpendicular to the axis 16 (this angle is known as the rake angle). Rake faces 17-19 allow and encourage metallic portions cut from barrel 1 to slide off or get pushed ahead of the rake faces 17-19 during the cutting operation. Axial rake angle of rake faces 17-19 is the slope of the planar face towards the center of the tool.

The perimeter of each main rake face surface 17′-19′ (illustrated, for instance, by referring to second rake face 18) includes two substantially straight sides 30, 31, that meet at respective locations adjacent to a center point 23 which is preferably on the axis 16, and a third side 32, 33, 34, 35, 36. Left side region 32 and right side region 33 each substantially follow respective parts of a first imaginary circle C1 (see FIG. 2) having a first radius R1 and a center on the axis 16. Middle region 34 between the left and right side regions 32, 33 substantially follows a part of a second imaginary circle C2 (see FIG. 2) having a second radius R2 and a center on the axis 16. The length of middle region 34 can coincide with width W of the groove 3 (FIG. 1). C2 presents the effective cutting edge diameter. Left transition region 35 and right transition region 36 extend between the respective side regions 32, 33 and the middle region 34. C1 defines the core diameter, or body clearance or relief diameter.

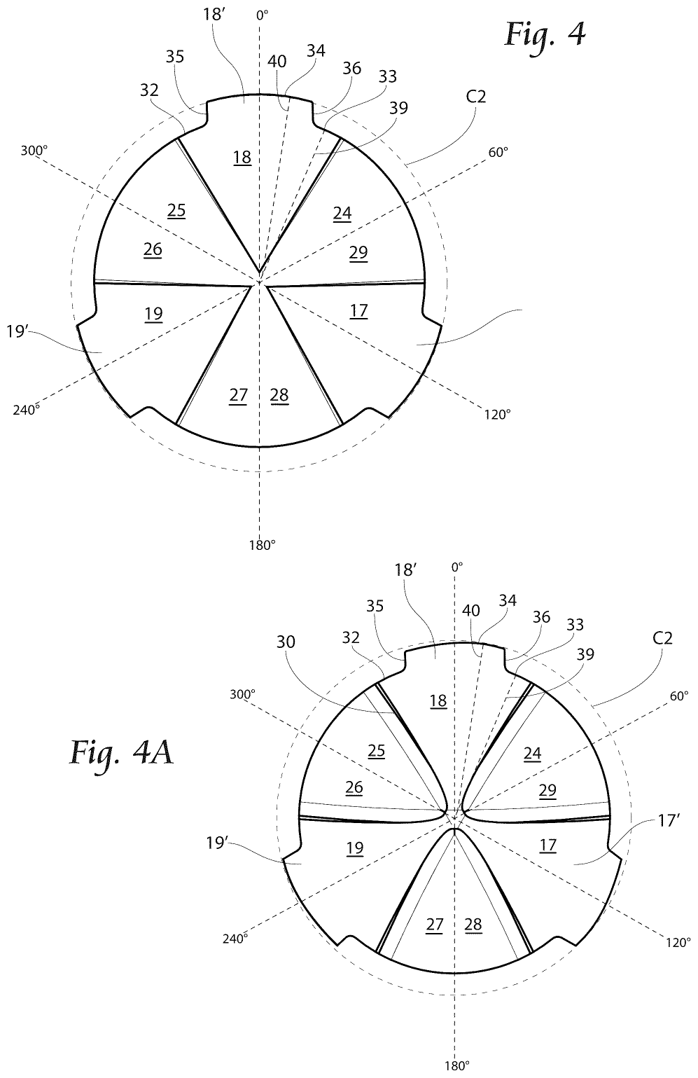

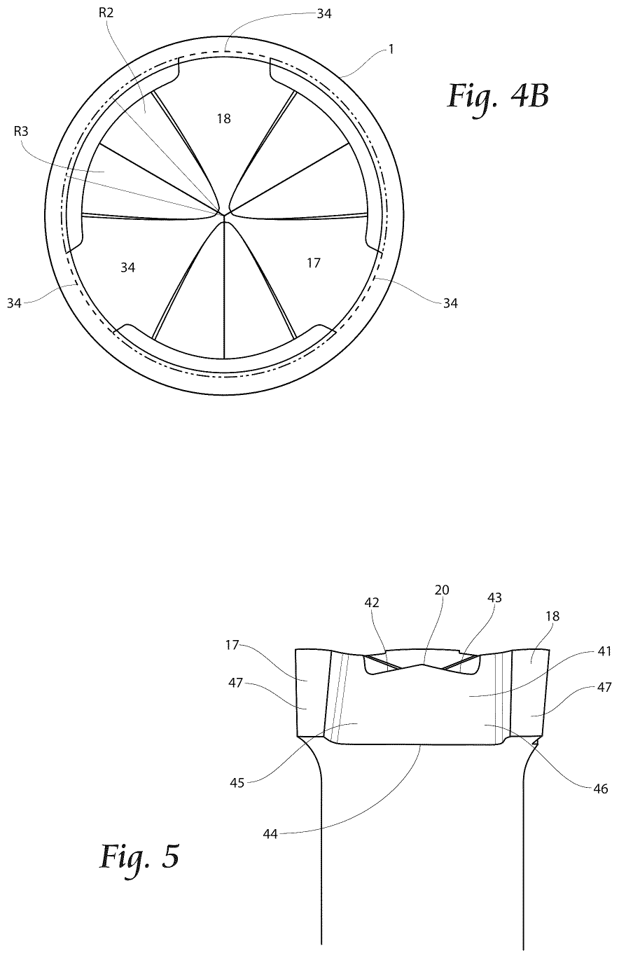

As noted above, the middle regions 34 substantially follow respective parts of the second imaginary circle C2; each middle region 34 can have a relief, i.e., for each middle region, the distance from the axis 16 can decrease over at least part of the middle region 34, extending in a clockwise direction (in the orientation depicted in FIG. 4) from its farthest counter-clockwise point at least partway toward its farthest clockwise point. This relief is also known as a lead, provided so that the tool can gradually lead into the barrel 1.

The cutting head 13 also comprises a first ridge 20, a second ridge 21 and a third ridge 22. The first, second and third ridges 20, 21 and 22 are each substantially straight, and each extend radially away from respective locations adjacent to the center point 23, along an imaginary plane that is perpendicular to the axis 16 and that includes the center point 23, to respective points that are on an imaginary cylindrical shape that shares the axis 16 and that includes the points on the first imaginary circle.

The cutting head 13 also comprises first through sixth sloped surfaces 24, 25, 26, 27, 28 and 29, respectively. Each of the sloped surfaces 24-29 is substantially planar.

The cutting head 13 also comprises first through sixth transition surfaces that each extend from one of the substantially straight sides 30, 31, of the main surfaces of the rake faces 17, 18, 19 to one of the first through sixth sloped surfaces 24-29. For example, in FIG. 3, one of the transition surfaces 37 extends from the substantially straight side 31 of the main surface of the second rake face 18 to the second sloped surface 25, and another of the transition surfaces 38 extends from one of the substantially straight sides of the main surface of the first rake face 17 to the fifth sloped surface 28. The transition surfaces extend from the respective substantially straight sides 30, 31 of the main surfaces 17, 18, 19 of the rake faces nearly vertically (“vertically” meaning in a plane that encompasses the axis 16), and curve somewhat (away from vertical) before they reach the respective sloped surfaces 24-29.

Referring now to FIG. 4, a schematic front view of the broaching tool 10 shows the front face of the cutting head 13. Referring to FIG. 4, with an imaginary overlay depicting 0-360 degrees of circle C2, and with 0 degrees bisecting the main surface 18′ of the second rake face 18, the main surface 18′ of the second rake face 18 extends from about 330 degrees to about 30 degrees, the first sloped surface 24 extends from about 30 degrees to about 60 degrees, the sixth sloped surface 29 extends from about 60 degrees to about 90 degrees, the main surface 17′ of the first rake face 17 extends from about 90 degrees to about 150 degrees, the fifth sloped surface 28 extends from about 150 degrees to about 180 degrees, the fourth sloped surface 27 extends from about 180 degrees to about 210 degrees, the main surface 19′ of the third rake face 19 extends from about 210 degrees to about 270 degrees, the third sloped surface 26 extends from about 270 degrees to about 300 degrees, and the second sloped surface 25 extends from about 300 degrees to about 330 degrees. The middle region 34 of the main surface 18′ of the second rake face 18 extends from about 342 degrees to about 18 degrees, the middle region 34 of the main surface 17′ of the first rake face 17′ extends from about 102 degrees to about 138 degrees, and the middle region 34 of the main surface 19′ of the third rake face 19 extends from about 222 degrees to about 258 degrees.

Respective left and right side regions 32, 33 of the main surfaces of each of the first, second and third rake faces 17-19 (including the left and right side regions 32 and 33 of the main surface of the second rake face 18) each follow respective parts of first imaginary circle C1 having a first imaginary radius R1 and a center on the axis 16 (as seen in FIG. 2), and the respective middle regions 34 of the main surfaces of each of the first, second and third rake faces 17-19 (including the middle region 34 of the main surface of the second rake face 18) each substantially follow respective parts of a second imaginary circle C2 having a second imaginary radius R2 and a center on the axis 16 (and can have a relief, as described above). As seen in FIG. 4, the first through sixth sloped surfaces 24, 25, 26, 27, 28 and 29 and the first through sixth transition surfaces 37 each extend away from the center 23 to the first imaginary circle C1.

Referring now to FIG. 4A, a second embodiment of the broaching tool 10 is shown. In this embodiment, the concept is illustrated that the configuration of the outer sides 30 of rake faces 17-19 can vary in shape from substantially straight sides 30 as shown in FIG. 4, to somewhat curved as shown in FIG. 4A.

Referring now to FIG. 4B a front view of the broaching tool 10 deployed and in-use operating on a metallic barrel 1 is shown. It can be seen that the second imaginary circle radius R2 is the resulting depth of groove 3 (not visible in this view), whereas a slightly smaller radius R3 represents the radius of bore 2 the barrel 1. For instance, in the case of a 0.357 rifled barrel, the barrel is configured to accept a 0.357″ (9.07 mm) bullet diameter, whereas the radius R3 of bore 2 in barrel 1 may be 0.348″ (8.84 mm). The difference between the two radii R2 and R3 defines the depth D (see FIG. 1) of the rifling or groove 3 applied to barrel 1. In this example, the depth D of the rifling would be 0.009″ (0.357″-0.348″).

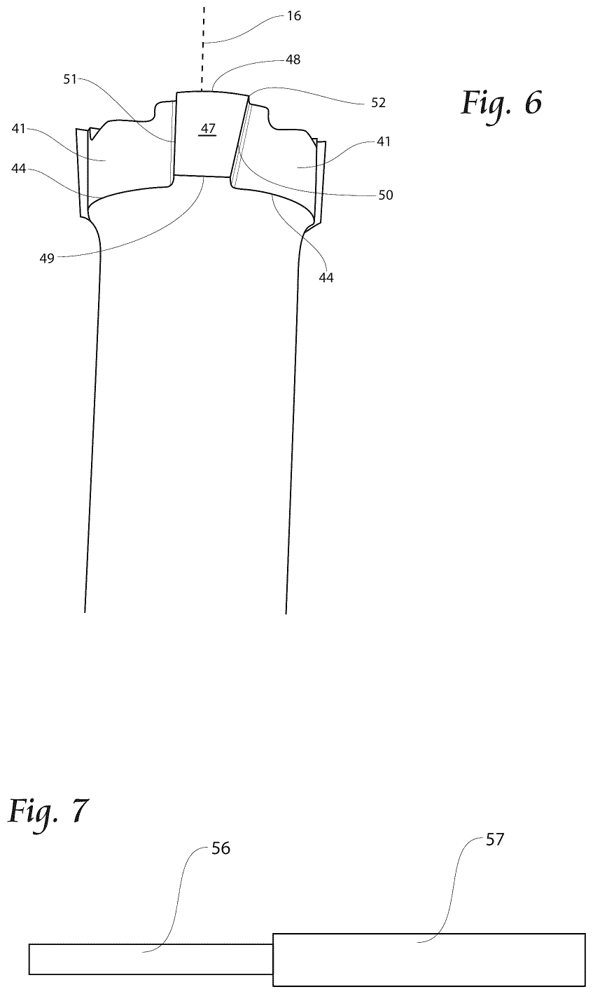

Referring now to FIGS. 5 and 6, they are side views of the cutting head 13 and a portion of the body 12 (the view in FIG. 6 being rotated about the axis about 60 degrees relative to the view in FIG. 5, and viewed slightly from underneath the view in FIG. 5). The circumferential periphery of the cutting head comprises first, second and third recessed surfaces 41 (one recessed surface 41 being visible in FIG. 5, two recessed surfaces 41 being visible in FIG. 6), and first, second and third outer surfaces 47 (portions of two outer surfaces 47 being visible in FIG. 5, one outer surface 47 visible in FIG. 6). Each of the first, second and third recessed surfaces 41 are shaped similarly to each other, and each of the first, second and third outer surfaces 47 are shaped similarly to each other.

Each of the first, second and third recessed surfaces 41 are located on an imaginary inner substantially cylindrical surface that encompasses the first imaginary circle C1, that has a radius equal to the first radius R1 or 39, and that shares the axis 16. As seen in FIG. 5, the first recessed surface 41 extends from the radially outermost ends 42, 43 of the sixth sloped surface 29 and the first sloped surface 24, respectively, to an edge 44 that follows part of a third imaginary circle (which is on the imaginary inner substantially cylindrical surface and is spaced from the front end of the broaching tool 10), and from a first recessed surface left edge 45 to a first recessed surface right edge 46. As seen in FIG. 5 (and in FIG. 3), the first sloped surface 24 (including the outermost end 43) slopes at a downward right angle of about 12 degrees from the first ridge 20 toward the second rake face 18, and the sixth sloped surface 29 (including the outermost end 42) slopes at a downward left angle of about 12 degrees from the first ridge 20 toward the first rake face 17.

Each of the first, second and third outer surfaces 47 is located substantially on an imaginary outer substantially cylindrical surface that encompasses the second imaginary circle C2, that has a radius equal to R2 or the second radius 40, and that shares the axis 16. Each of the first, second and third outer surfaces can have an axial relief and/or a radial relief. As seen in FIG. 6, the first outer surface 47 extends from the middle region 48 (i.e., the radially outermost end of the first rake face 17) of the main surface of the first rake face 17 to an opposite edge 49, and from a first cutting edge 50 (on the right side of the first outer surface 47) to a first outer surface following edge 51 (on the left side of the first outer surface 47). The first cutting edge 50 (like the cutting edges on the second and third rake faces) makes an angle of about 8 degrees relative to the axis 16. Where the first cutting edge 50 meets the middle region 48 is a first corner 52 (the other rake faces likewise have respective cutting corners). As noted above, each outer surface 47 can have an axial relief and/or a radial relief, e.g., (in the case of the one such outer surface 47), the distance from the axis 16 can decrease from the first cutting edge 50 at least partway toward the first outer surface following edge 51, and/or from the middle region 48 toward the opposite edge 49.

There are a number of transition portions, between the outer surfaces 47 and the body 12, between the recessed surfaces 41 and the body, between the cutting edges and the recessed surfaces, and between the following edges and the recessed surfaces. The transition portions between the cutting edges and the recessed surfaces extend close to radially from the cutting edges toward the axis, and curve slightly as they approach the recessed surfaces. There is also a circumferential transition area 53 between the shank 11 and the body 12 (see FIG. 1).

Upon rotating the broaching tool 10 about the axis 16 and advancing the broaching tool along the axis 16 in a forward direction, the first, second and third corners 52 each travel in a circular helix pattern, each point on the circular helix patterns spaced from the axis 16 by a distance that is greater than a distance that any point on the shank 11 is spaced from the axis 16. The respective cutting corners 52 are substantially uniformly spaced on the forward end of the cutting head 13.

FIG. 7 is a schematic conceptual drawing depicting a CNC lathe machine, including a pushing component 56 and a bore-containing structure holder 57. The CNC lathe machine is configured to provide synchronized rotary and forward motion, i.e., such that a broaching tool (engaged by the pushing component 56) and a bore-containing structure (engaged by the bore-containing structure holder 57) are rotated relative to one another about a first axis, while the broaching tool and the bore-containing structure are being moved relative to one another along the first axis.

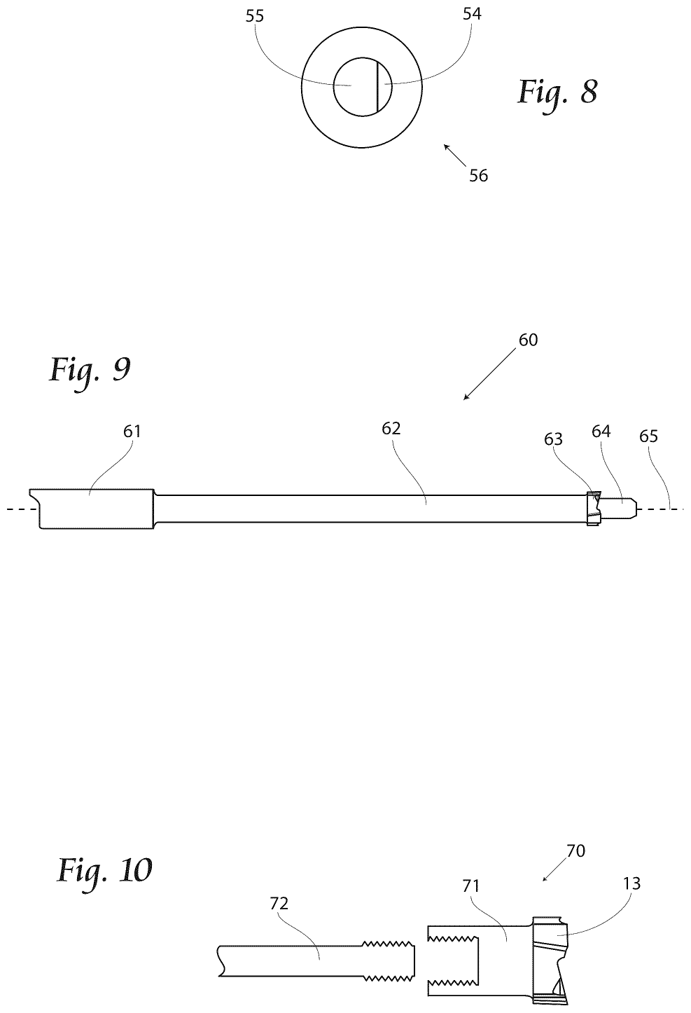

FIG. 8 is a schematic conceptual drawing depicting indexing surfaces 54 and 55 of the pushing component 56 with surfaces that cooperate with indexing surfaces on a back face of the shank of a broaching tool.

In some embodiments, a broaching tool in accordance with the present invention can be pulled (rather than being pushed) relative to a bore-containing structure.

FIG. 9 is a schematic side view depicting a second embodiment of a broaching tool 60 in accordance with the present invention.

Referring to FIG. 9, the broaching tool 60 is similar to the broaching tool 10, except that in addition to a shank 61, a body 62 and a cutting head 63, the broaching tool 60 also comprises a pilot portion 64. Each point on the pilot portion 64 is spaced from the axis 65 of the broaching tool 60 a distance that is less than a distance that each point on the circular helix patterns created by the first second and third corners 52 as described previously each travel in a circular helix pattern are spaced from the axis 65 of the broaching tool 60. The pilot portion 64 extends farther in the forward direction than any other part of the broaching tool 60, such that upon moving the broaching tool 60 and a bore-containing structure relative to one another along the axis 65, the pilot portion 64 enters the bore prior to the cutting head 63 of the broaching tool 60 cutting a groove pattern in the bore-containing structure.

FIG. 10 is a schematic side view depicting part of a third embodiment of a broaching tool 70 in accordance with the present invention. The broaching tool 70 is similar to the broaching tool 10, except that the cutting head 71 or 13 (of the broaching tool 70) is removable from the body 72 (of the broaching tool 70). The body 72 can be provided with external threads that are capable of being screw-threaded into internal threads of the cutting head 71.

FIG. 11 is a schematic side view depicting part of a fourth embodiment of a broaching tool 80 in accordance with the present invention. The broaching tool 80 is similar to the broaching tool 10, except that the body 81 (of the broaching tool 80) is removable from the shank 82 (of the broaching tool 80). Referring to FIG. 11, the body 81 has external threads that are capable of being screw-threaded into internal threads of the shank 82.

FIG. 12 is a schematic side view depicting a fifth embodiment of a broaching tool 90 in accordance with the present invention. The broaching tool 90 is similar to the broaching tool 10, except that the shank 92 has a ramp portion 93. In a sequence of at least first through tenth shank imaginary planes that are perpendicular to the axis of the broaching tool and that are spaced evenly, respective dimensions of the ramp portion 93 increase as the distance from the cutting head 91 increases, and for the sequence of first through tenth shank imaginary planes, the diameter of the ramp portion 93 increases substantially linearly.

FIG. 13 is a schematic side view depicting part of a sixth embodiment of a broaching tool 100 in accordance with the present invention. The broaching tool 100 is similar to the broaching tool 10, except that the body 102 has a ramp portion 103. In a sequence of at least first through tenth shank imaginary planes that are perpendicular to the axis of the broaching tool and that are spaced evenly, respective dimensions of the ramp portion 103 decrease as the distance from the cutting head 101 increases, and for the sequence of first through tenth shank imaginary planes, the diameter of the ramp portion 103 increases substantially linearly.

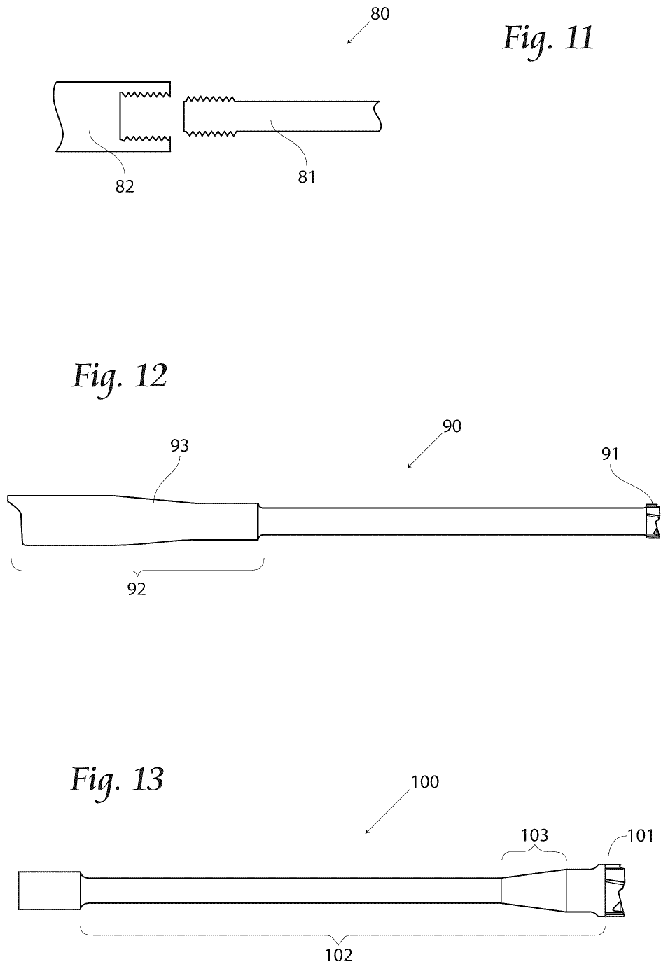

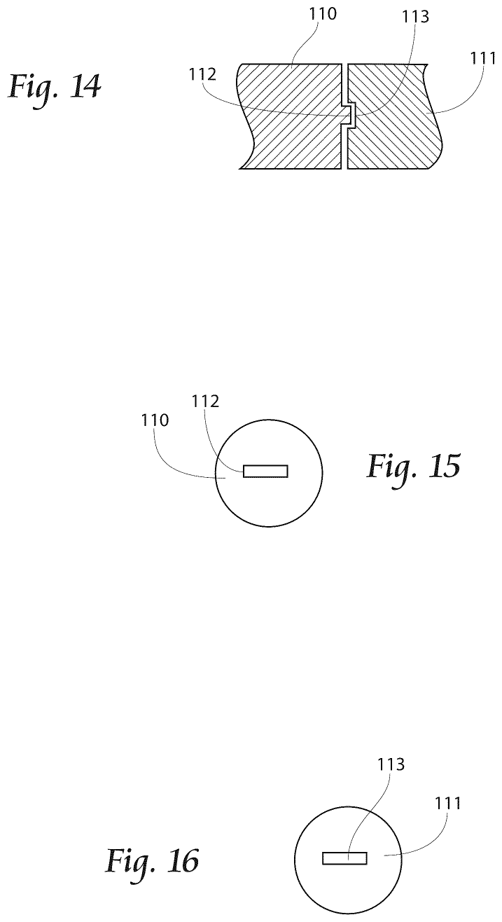

Referring now to FIG. 14, a schematic sectional view is shown depicting part of a pushing component 110 and part of a broaching tool 111. The pushing component 110 comprises an indexing region comprising a protruding rib 112 that fits tightly within an indexing region on the broaching tool 111 in the form of a groove 113. FIG. 15 is a schematic view depicting a front surface of the pushing component 110, and FIG. 16 is a schematic view depicting a rear surface of the broaching tool 111.

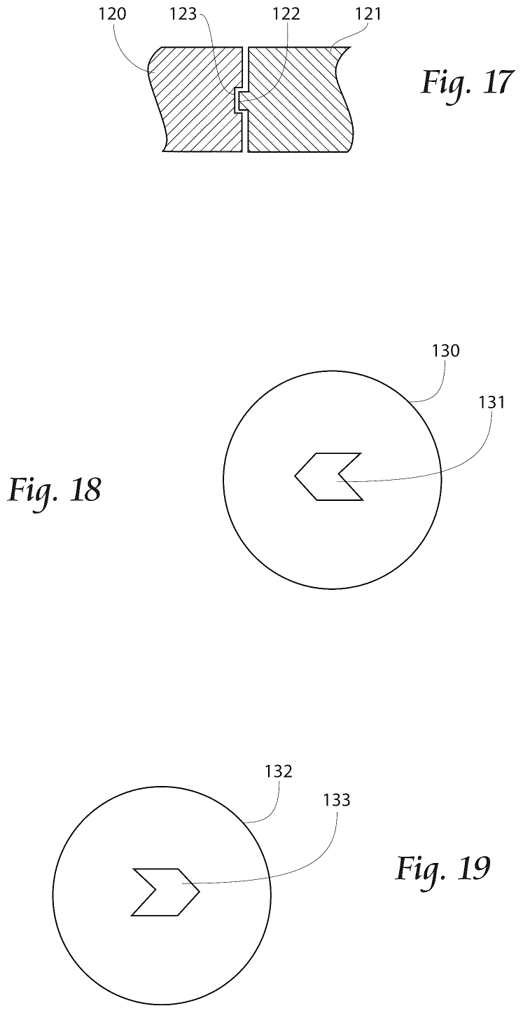

Referring now FIG. 17, a schematic sectional view is shown depicting part of a pushing component 120 and part of a broaching tool 121. The broaching tool 121 comprises an indexing region comprising a protruding rib 122 that fits tightly within an indexing region on the pushing component 120 in the form of a groove 123. FIG. 18 is a schematic view depicting a front surface of a pushing component 130. The pushing component comprises a protrusion in the form of a six-sided protrusion 131, and FIG. 19 is a schematic view depicting a rear surface of a broaching tool 132. The broaching tool 132 comprises a recess in the form of a six-sided recess 133. The protrusion 131 of the pushing component 130 fits tightly in the recess 133 in only a single rotational orientation of the broaching tool 132 relative to the pushing component 130.

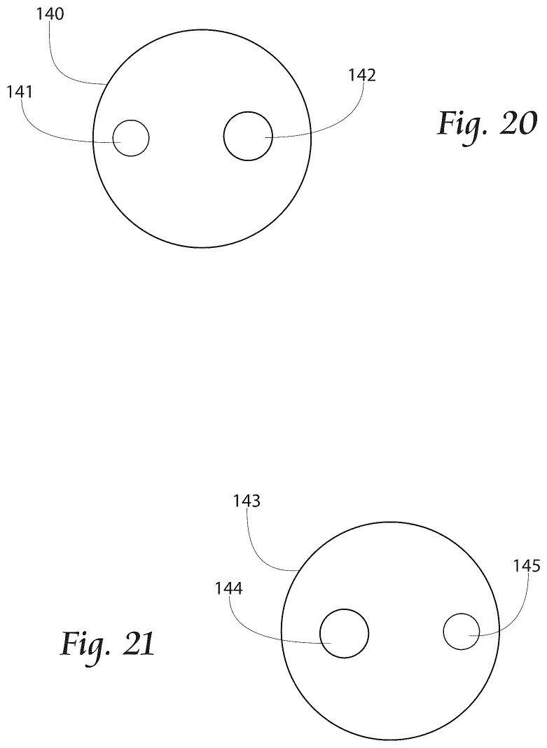

Referring now FIG. 20, a schematic view is shown depicting a front surface of a pushing component 140. The pushing component 140 comprises two protrusions 141 and 142, each in the form of a cylindrical protrusion. FIG. 21 is a schematic view depicting a rear surface of a broaching tool 143. The broaching tool 143 comprises two recesses 144 and 145, each in the form of a cylindrical recess (of differing diameters). The protrusion 141 of the pushing component 140 fits tightly in the recess 145 of the broaching tool 143, and the protrusion 142 of the pushing component 140 fits tightly in the recess 144 of the broaching tool 143. Due to the protrusions 141 and 142 (and the recesses 144 and 145) being of different sizes, the protrusions 141 and 142 can fit in the recesses 144 and 145 in only a single rotational orientation of the broaching tool 143 relative to the pushing component 140. Alternatively, the protrusions 141 and 142 (and the recesses 144 and 145) can be the same size, such that the protrusions 141 and 142 can fit in the recesses 144 and 145 in either of two rotational orientations of the broaching tool 143 relative to the pushing component 140, the two rotational orientations being offset from one another by 180 degrees.

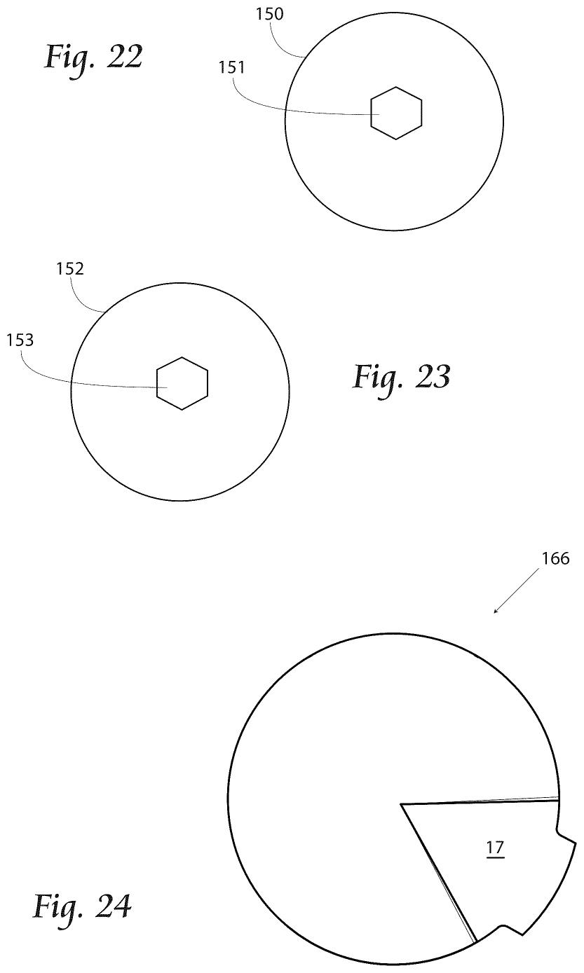

FIG. 22 is a schematic view depicting a front surface of a pushing component 150. The pushing component 150 comprises a protrusion in the form of a hexagonal protrusion 151. FIG. 23 is a schematic view depicting a rear surface of a broaching tool 152. The broaching tool 152 comprises a recess in the form of a hexagonal recess 153. The protrusion 151 of the pushing component 150 fits tightly in the hexagonal recess 153 in any of six rotational orientations of the broaching tool 152 relative to the pushing component 150, each offset by 60 degrees, 120 degrees, 180 degrees, 240 degrees and 300 degrees relative to the other orientations.

Referring now to FIG. 24, a schematic front view of a seventh embodiment of a broaching tool 166 in accordance with the present invention is shown. The broaching tool 160 is similar to the broaching tool 10, except that the broaching tool 160 has only a single rake face 17. The regions corresponding to where the first embodiment includes second and third rake faces can instead be planar (as shown), or shaped like the sloped surfaces 24, 25, 26, 27, 28 and 29 in the first embodiment (not shown).

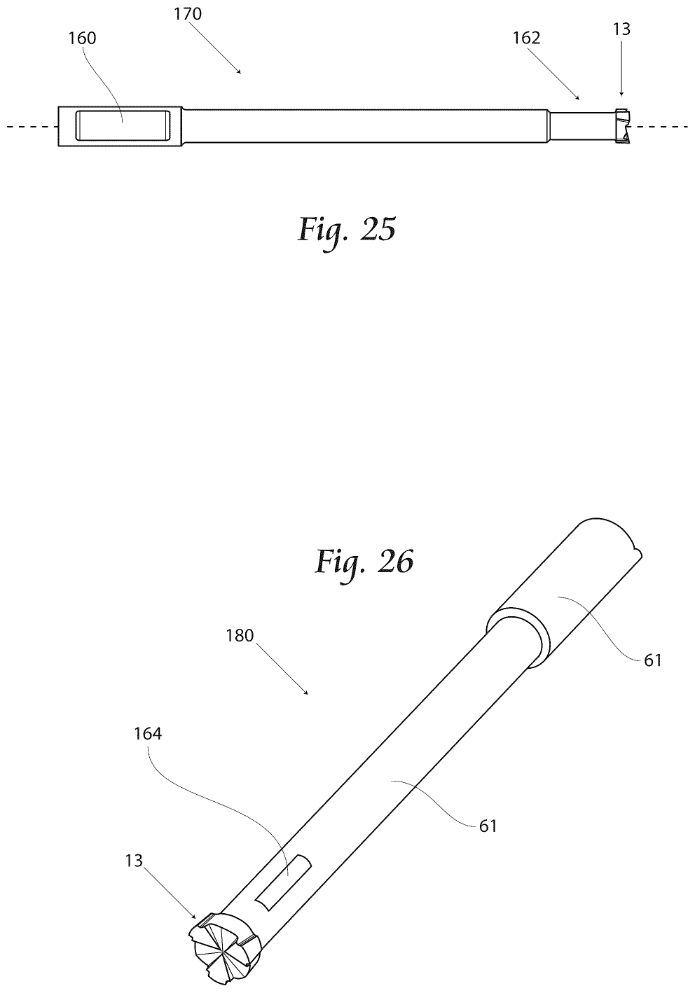

Referring now to FIG. 25, a side view of an eighth embodiment of a broaching tool 170 is shown. In this embodiment, a shank flat 160 is provided. The shank flat 160 feature can be provided to orient and position the tool 170, and to prevent tool 170 from spinning in-use. An optional neck down relief feature 162 can be provided rearward of cutting head 13 to provide further clearance.

Referring now to FIG. 26, a side view of a ninth embodiment of a broaching tool 180 is shown. In this embodiment, one or more guide pads 164 can be provided about shank 61. Guide pads 164, positive relief features rearward of cutting head 13, can stabilize broaching tool 180 by providing an additional point(s) of potential contact point between the broaching tool 180 and the bore 2 of barrel 1 during the cutting operation, in addition to the operational portion of cutting head 13 contacting the bore 2 of barrel 1. An additional rearward contact point as guide pad 164 has a stabilizing effect on the cutting operation, by minimizing unintended off-axis movement of the broaching tool 180 as the tool 180 is advanced through the bore 2.

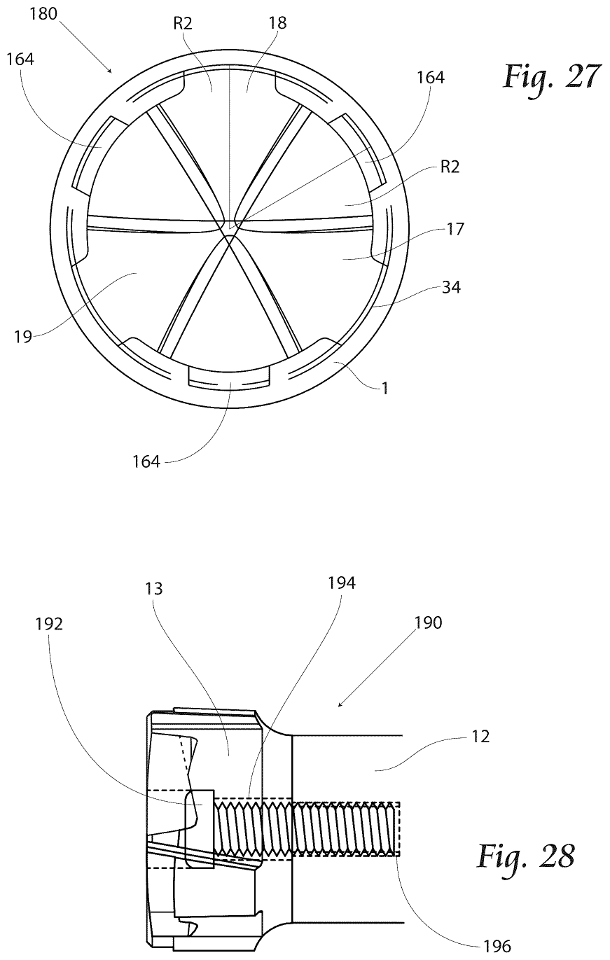

In one embodiment, as shown in FIG. 27 three guide pads 164 can be provided about the periphery of broaching tool 180. In a preferred embodiment, guide pads 164 are positioned about the periphery of the broaching tool 180 alternating between edges 34 of rake faces 17-19. Guide pads 164 can extend to a radial extent of R2 (or if desired, to the shorter radii R1 or R3).

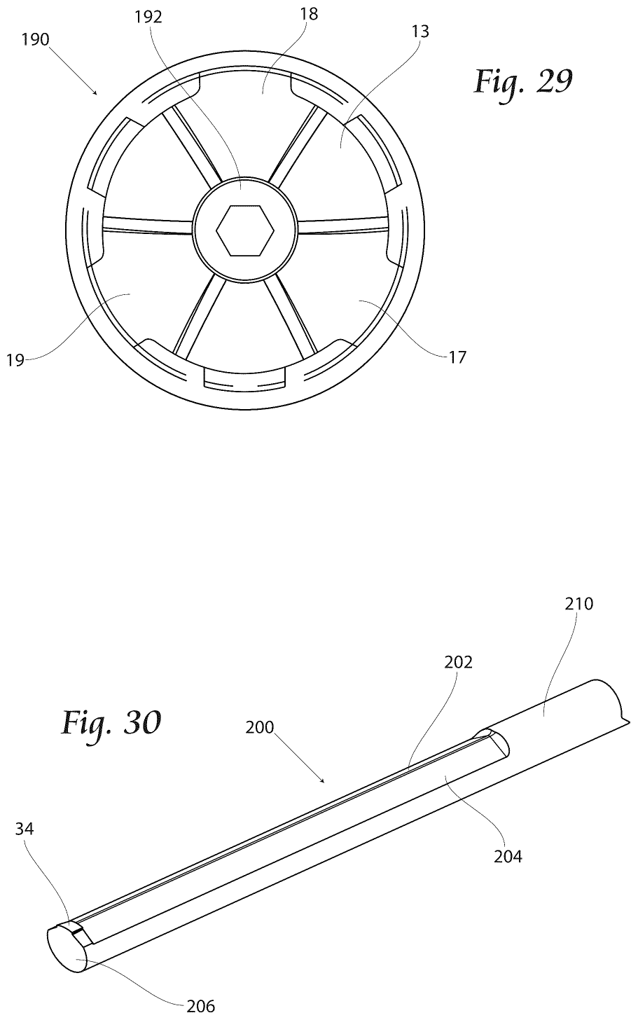

Referring now to FIG. 28, a side view of a tenth embodiment of a broaching tool 190 is shown. In this embodiment, cutting head 13 is selectively removable from body 12. A threaded screw 192 can be provided to secure cutting head 13 to body 12 first through cutting head bore 194, and into threaded body bore 196. FIG. 29 is a front, in-use view thereof, shows threaded screw 192 secured through cutting head 13.

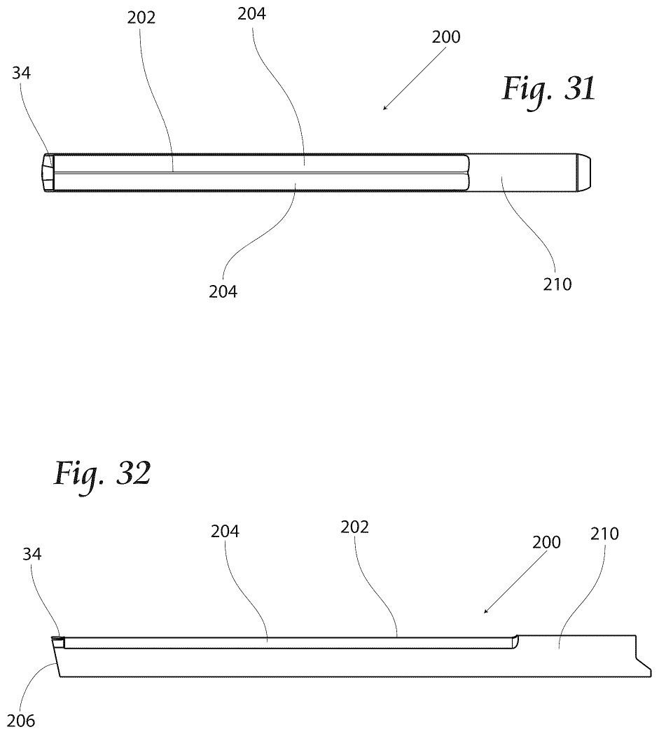

Referring now to FIGS. 30-32, a top perspective, top, and side views of an eleventh embodiment of a broaching tool 200 is shown. In this embodiment, a flute 202 is rearward of edge 34 of planar rake face 206. Flanking flute 202 are two side-flute relief surfaces 204.

In another embodiment in accordance with the present invention, there is provided a broaching tool that has only a single rake face, and that has a pilot portion.

In one aspect, the present invention provides broaching tools that can be used to produce rifled gun barrels on standard CNC lathes, by a simple method that enables general machines shops to rifle the gun barrels without the need to obtain specialized (and very costly) equipment. Prior to the present invention, there did not exist any other broaching tool that enables production of barrel rifling using a standard CNC lathe or turning center with the degree of accuracy and speed at which rifling can be machined using a broaching tool in accordance with the present invention in a method in accordance with the present invention.

Any two or more structural parts of the broaching tools described herein can be integrated. Any structural part of the broaching tools described herein can be provided in two or more parts. Similarly, any two or more functions can be conducted simultaneously, and/or any function can be conducted in a series of steps.

Each component described herein can be a unitary one-piece structure. In some cases, if suitable, two or more structural parts of the devices described herein can be integrated, and/or a component can be provided in two or more parts (which are held together, if necessary). Similarly, any two or more functions can be conducted simultaneously, and/or any function can be conducted in a series of steps.

Furthermore, while certain embodiments of the present invention have been illustrated with reference to specific combinations of elements and attributes, various other combinations may also be provided without departing from the teachings of the present invention. Thus, the present invention should not be construed as being limited to the particular exemplary embodiments described herein and illustrated in the Figures, but may also encompass combinations of elements and attributes of the various illustrated embodiments.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A broaching tool for rifling a gun barrel comprising:
a shank;
a body;
a cutting head;
an axis of said broaching tool extending from a rearward end of said broaching tool at said shank to a forward end of said broaching tool at said cutting end, said axis extending through said shank, said body and said cutting head;
said body positioned forward relative to said shank;
said cutting head positioned forward relative to said body;
said cutting head comprising at least a first rake face, said first rake face comprising a first cutting edge,
said first cutting edge comprising a first cutting corner at a forward end of said cutting head;
said first rake face configured such that upon rotating at least one of said broaching tool and said gun barrel about said axis of said broaching tool and advancing said tool along said axis of said broaching tool in a forward direction relative to said gun barrel, said first corner travels in a first circular helix pattern, each point on said first circular helix pattern spaced from said axis of said broaching tool by a distance that is greater than a distance that any point on said shank or said body is spaced from said axis of said broaching tool.

2. A broaching tool as recited in claim 1, wherein:
said cutting head comprises at least two rake faces;
said at least two rake faces each comprising a respective cutting corner at said forward end of said cutting head.

3. A broaching tool as recited in claim 2, wherein said respective cutting corners of said at least two rake faces substantially uniformly spaced about said forward end of said cutting head.

4. A broaching tool as recited in claim 2, wherein:
said first cutting corner and said second cutting corner are located on an imaginary substantially circular pattern, said imaginary substantially circular pattern is in a plane perpendicular to said axis of said broaching tool, a spacing between said first cutting corner and said second cutting corner on said imaginary substantially circular pattern is in a range of from 115 degrees to 125 degrees.

5. A broaching tool as recited in claim 1, wherein:
said cutting head further comprises a second rake face and a third rake face;
said second rake face comprises a second cutting edge;
said second cutting edge comprises a second corner at said forward end of said cutting head;
said second rake face is configured such that upon rotating said broaching tool about said axis of said broaching tool and advancing said broaching tool along said axis of said broaching tool in a forward direction, said second corner travels in a second circular helix pattern, each point on said second circular helix pattern spaced from said axis of said broaching tool by a distance that is greater than said distance that any point on said shank or said body is spaced from said axis of said broaching tool,
said third rake face comprises a third cutting edge,
said third cutting edge comprises a third corner at said forward end of said cutting head,
said third rake face is configured such that upon rotating said broaching tool about said axis of said broaching tool and advancing said broaching tool along said axis of said broaching tool in a forward direction, said third corner travels in a third circular helix pattern, each point on said third circular helix pattern spaced from said axis of said broaching tool by a distance that is greater than said distance that any point on said shank or said body is spaced from said axis of said broaching tool.

6. A broaching tool as recited in claim 1, wherein:
said broaching tool further comprises a pilot portion,
each point on said pilot portion is spaced from said axis of said broaching tool a distance that is less than a distance that each point on said first circular helix pattern is spaced from said axis of said broaching tool.

7. A broaching tool as recited in claim 6, wherein said pilot portion extends farther in said forward direction than any other part of said broaching tool.

8. A broaching tool as recited in claim 1, wherein said cutting head is removable from said body.

9. A broaching tool as recited in claim 8, wherein:
said cutting head has a region with external threads,
said body has a region with internal threads, and
said external threads of said cutting head are capable of being screw-threaded into said internal threads of said body.

10. A broaching tool as recited in claim 8, wherein:
said body has a region with external threads,
said cutting head has a region with internal threads, and
said external threads of said body are capable of being screw-threaded into said internal threads of said cutting head.

11. A broaching tool as recited in claim 1, wherein said body is removable from said shank.

12. A broaching tool as recited in claim 11, wherein:
said body has a region with external threads,
said shank has a region with internal threads, and
said external threads of said body are capable of being screw-threaded into said internal threads of said shank.

13. A broaching tool as recited in claim 1, wherein:
said shank comprises at least a shank first ramp portion,
in a sequence of at least first through tenth shank imaginary planes that are perpendicular to said axis of said broaching tool and that are spaced evenly, respective dimensions of said shank first ramp portion decrease as said distance from said cutting head increases.

14. A broaching tool as recited in claim 1, wherein:
said body comprises at least a body first ramp portion,
in a sequence of at least first through tenth body imaginary planes that are perpendicular to said axis of said broaching tool and that are spaced evenly, respective dimensions of said body first ramp portion increase as said distance from said cutting head increases.

15. A broaching tool as recited in claim 1, wherein said shank comprises at least a first indexing region.

16. A broaching tool as recited in claim 15, wherein said first indexing region comprises at least first and second indexing surfaces at a rear face of said shank, and said first and second indexing surfaces are non-co-planar.

17. A broaching tool as recited in claim 15, wherein said indexing region comprises at least a first groove.

18. A broaching tool as recited in claim 15, wherein said indexing region comprises at least a first rib.

19. A broaching tool as recited in claim 15, wherein said indexing region comprises at least a first non-cylindrical, non-conical, non-frustoconical recess.

20. A broaching tool as recited in claim 15, wherein said indexing region comprises at least a first non-cylindrical, non-conical, non-frustoconical protrusion.

21. A broaching tool as recited in claim 15, wherein said indexing region comprises at least two protrusions.

22. A broaching tool as recited in claim 15, wherein said indexing region comprises at least two recesses.

23. A broaching tool as recited in claim 15, wherein said indexing region comprises at least one protrusion and at least one recess.

24. A method of forming one or more grooves in a bore-containing structure, said method comprising: rotating at least one of a first broaching tool and a bore-containing structure relative to one another about a first axis, said first broaching tool and said bore-containing structure aligned such that said first axis is an axis of said first broaching tool and an axis of a bore in said bore-containing structure, and moving said first broaching tool and said bore-containing structure relative to one another along said first axis;
so that a cutting head of said first broaching tool cuts at least a first groove pattern in said bore-containing structure around said bore, said first groove pattern comprising at least a first circular helix relative to said first axis;
said first broaching tool, comprising:
a shank;
a body; and
said cutting head;
said axis extending from a rearward end of said first broaching tool to a forward end of said first broaching tool through said shank, said body and said cutting head;
said body is forward relative to said shank;
said cutting head is forward relative to said body;
said cutting head comprises at least a first rake face;
said first rake face comprises a first cutting edge;
said first cutting edge comprises a first corner at a forward end of said cutting head.

25. A method as recited in claim 24, wherein said moving said first broaching tool and said bore-containing structure relative to one another along said first axis causes said first broaching tool to move forward relative to said bore-containing structure.

26. A method as recited in claim 24, wherein:
said cutting head comprises at least two rake faces, including said first rake face,
each rake face comprises a respective cutting corner at said forward end of said cutting head, and
said respective cutting corners of said at least two rake faces are substantially uniformly spaced on said forward end of said cutting head.

27. A method as recited in claim 24, wherein:
said cutting head further comprises a second rake face and a third rake face,
said second rake face comprises a second cutting edge,
said second cutting edge comprises a second corner at said forward end of said cutting head,
said third rake face comprises a third cutting edge,
said third cutting edge comprises a third corner at said forward end of said cutting head, upon said rotating said first broaching tool and said bore-containing structure relative to one another about said first axis, and said moving said first broaching tool and said bore-containing structure relative to one another along said first axis, said second cutting edge cuts a second groove pattern in said bore-containing structure around said bore, and said third cutting edge cuts a third groove pattern in said bore-containing structure around said bore, said second groove pattern a second circular helix relative to said first axis, said third groove pattern a third circular helix relative to said first axis, said second circular helix axially offset relative to said first circular helix, said third circular helix axially offset relative to said first circular helix and relative to said second circular helix.

28. A method as recited in claim 24, wherein:
said first broaching tool further comprises a pilot portion,
said pilot portion extends farther in said forward direction than any other part of said first broaching tool, and
upon said moving said first broaching tool and said bore-containing structure relative to one another along said first axis, said pilot portion enters said bore prior to said cutting head of said first broaching tool cutting said first groove pattern in said bore-containing structure.

29. A method as recited in claim 24, wherein:
said method further comprises:
rotating said first broaching tool and said bore-containing structure relative to one another about said first axis, said first broaching tool and said bore-containing structure aligned such that said first axis is an axis of said first broaching tool and an axis of a bore in said bore-containing structure, and
moving said first broaching tool and said bore-containing structure relative to one another along said first axis,
so that said cutting head of said first broaching tool cuts at least a second groove pattern in said bore-containing structure around said bore, said second groove pattern comprising at least one circular helix relative to said first axis.

30. A method as recited in claim 29, wherein said method further comprises indexing said first broaching tool relative to said bore-containing structure prior to said rotating said first broaching tool and said bore-containing structure relative to one another about said first axis, and moving said first broaching tool and said bore-containing structure relative to one another along said first axis.

31. A method as recited in claim 30, wherein coils of said second groove pattern are offset axially from coils of said first groove pattern by a distance equal to from 45% to 55% of a shift of said first groove pattern.

32. A method as recited in claim 30, wherein coils of said second groove pattern are offset axially from coils of said first groove pattern by a distance outside said range of from 45% to 55% of a shift of said first groove pattern.
